(19) United States
(12) Patent Application Publication
(10) Pub. No.: US 2017/0132891 A1
(43) Pub. Date: May 11, 2017

(54) Security Tag With Swivel Head

(71) Applicant: B&G PLASTICS, INC., Union, NJ (US)

(72) Inventors: Michael NORMAN, East Brunswick, NJ (US); Daniel V. CUNNEEN, Waldwick, NJ (US); Alex TETIYEVSKY, Springfield, NJ (US); Jake STRASSBURGER, South Plainfield, NJ (US)

(73) Assignee: B&G PLASTICS, INC., Union, NJ (US)

(21) Appl. No.: 15/343,794

(22) Filed: Nov. 4, 2016

Related U.S. Application Data
(60) Provisional application No. 62/251,167, filed on Nov. 5, 2015.

(51) Int. Cl. G08B 13/24

(52) U.S. Cl. CPC G08B 13/2434

(57) ABSTRACT

A security tag with a housing, a swivel head, electronic security device, a chamber, a swivel lock, and a locking pin. The housing has two housing sections and first and second ends. The electronic security device is disposed between the two housing sections. The chamber is connected to the first end of the housing and has an opening. The swivel lock is connected to a disc by a neck. The disc is rotatably disposed in the chamber and the neck passes through the opening in the chamber. The locking pin engages the swivel lock to secure an article to the tag.

This application claims priority from provisional application Ser. No. 62/251,167, filed on Nov. 5, 2015, which is incorporated herein in its entirety.

### FIELD OF THE INVENTION

The present invention is a security tag with a swivel head. In particular, the present invention relates to a security tag with a swivel head that includes an electronic security device.

### BACKGROUND OF INVENTION

Theft deterrent security tags attached to clothing, shoes and a wide variety of merchandise are well known. Electronic tags attached to articles have a wide variety of uses, including tracking, inventory control and security. These electronic tags can also provide electronically readable information pertaining to the articles.

These tags or markers may include radio frequency identification (RFID) tags or electronic article surveillance (EAS) tags. EAS tags may be used with an alarm system to provide theft deterrence by monitoring the location of the tags and any unauthorized movement of the article containing the EAS tag from a predetermined area. The tags can be enclosed in or attached to a variety of different devices, such as holders or housings, which accommodate the electronic tag and are used to attach the tags to articles. The tags are secured to the article so that they remain with the article until after the time of purchase.

With many of the EAS markers, by nature of the marker itself or by the article to which it attached, location of the EAS marker on the article is readily apparent to the prospective purchaser. Since the purchaser is aware of the presence of the EAS marker, the purchaser may attempt to remove the EAS marker in an unauthorized manner to defeat the electronic surveillance system.

One method of attaching an EAS marker to an article is through the use of a security tag, such as the one shown in U.S. Pat. No. 6,624,753, which provides a housing for supporting the EAS marker. A strap or cable tie is attached to the housing and the strap may be inserted into or around the article to be protected and permanently attached again to the housing. In the past, individuals have attempted to remove the security tag by twisting the housing to rotate the tag with respect to the strap. This causes tension in the strap which, upon application of sufficient force, may break the strap and allow the tag to be removed from the article. Thus, while it is desirable to use security tags for various applications, prior art security tags suffer from disadvantages.

Certain prior art security tags do provide a rotatable connection between the article to be protected and the housing of such hang tag. For example, U.S. Pat. No. 7,518,521 discloses a security tag including a rotating inner core which cooperates with a wire element for attaching the tag to an article to be protected. However, it will be appreciated by those skilled in the art that applications exists in the marketplace which require a plastic strap, as compared to the wire or line of the mentioned publication. Moreover, the prior art design disclosed in the '521 patent can present both manufacturing and assembly issues, which increase the cost and complexity of such product.

Another security tag having a rotatable head is disclosed in U.S. Pat. No. 7,183,914. Although the '914 patent discloses a tag employing a plastic strap, the design requires the strap to pass through a portion of the rotatable head, leaving a tail portion extending from the head after the tag is secured to the article. This exposed tail can be unsightly and/or undesirable in a retail setting. Moreover, the manufacture of the head/strap assembly of the '914 patent is complex and expensive.

Accordingly, there is a need for a security tag that can both support an EAS marker and be secured to an article via a rotatable connection, which reduces the likelihood that the security tag can be removed from the article in an unauthorized manner. There is a further need in the art for this same security tag to be easily and securely attached to an article, as well as simple and cost efficient to manufacture. It is, therefore, desirable to provide a tag housing which may be secured to an article and cannot be readily removed therefrom.

### SUMMARY OF THE INVENTION

In accordance with the present invention, a security tag with a swivel head is provided. In one embodiment, the security tag comprises, consists of or consists essentially of a housing, an electronic security device, first and second opposing outwardly curved walls, a swivel lock, and a locking pin. The housing includes first and second housing sections having first and second side walls with perimeters and first and second ends. The first and second housing sections can have first and second perimetrical side walls that extend from the perimeters of the first and second side walls, respectively. When the first and second housing sections are joined together, an enclosed space bounded by the first and second perimetrical side walls is formed therebetween. The perimeter of the first side wall can be less than the perimeter of the second side wall so that the first side wall snugly engages the second side wall, when they are joined together, and the first and second housing sections snap-fit together.

An electronic security device can be disposed between the two housing sections to provide protection against theft and/or to identify the goods attached to the tag for inventory control. The electronic security device can be a radio frequency identification (RFID) device or an electronic article surveillance (EAS) device.

The first and second opposing outwardly curved walls are connected to the first end of each housing section. When the two housing sections are joined together to form the housing, the opposing outwardly curved walls form a chamber and an opening opposite the housing.

The swivel lock has a body connected to a retainer by a neck. A longitudinal axis extends from the retainer through the neck to the body. The retainer extends radially from the longitudinal axis and the neck and is rotatably disposed in the chamber. The retainer can be disc-shaped or substantially round and can have a diameter. The opening formed by the first and second opposing outwardly curved walls has a diameter that is smaller than the diameter of the retainer. The neck passes through the opening. The body of the swivel lock can be concave and has an aperture, preferably located in the central portion of the body.

The locking pin is secured to the body of the swivel lock and can have a base and a shaft that extends from the base. The shaft is inserted into the aperture in the body of the swivel lock to secure the locking pin to the swivel lock. The locking pin can have a bulbous distal end that passes through the aperture in the swivel lock body and cannot be removed without damaging the swivel lock body. The base of the locking pin can be substantially flat and substantially round.

In another embodiment, the security tag comprises, consists of or consists essentially of a housing, an electronic security device, a globe-shaped housing, a swivel lock and a locking pin. This embodiment is substantially the same as the first embodiment except that the outwardly curved walls on the first end of the housing are replaced by the globe-shaped structure.

### BRIEF DESCRIPTION OF THE FIGURES

The preferred embodiments of the security tag with a swivel head of the present invention, as well as other objects, features and advantages of this invention, will be apparent from the accompanying drawings wherein:

FIG. 1 is an exploded view of the security tag with a swivel head of the present invention.

FIG. 2 is a front view of the assembled security tag with a swivel head of the present invention.

FIG. 3 is a left side view of the security tag with a swivel head shown in FIG. 2.

FIG. 4 is a right side view of the security tag with a swivel head shown in FIG. 2.

FIG. 5 is a top view of the security tag with a swivel head shown in FIG. 2.

FIG. 6 is a rear view of the security tag with a swivel head shown in FIG. 2.

FIG. 7 is a peripheral front side view of the security tag with a swivel head shown in FIG. 2 prior to the insertion of the locking pin into the swivel lock.

FIG. 8 is a peripheral front side view of the security tag with a swivel head shown in FIG. 2 after the insertion of the locking pin into the swivel lock.

### DETAILED DESCRIPTION OF THE INVENTION

The present invention is a security tag with a swivel head that is attached to an article to prevent theft and to facilitate electronic identification of the article. The security tag has a housing with a chamber formed on one end. The chamber encloses a disc that is connected through an opening in the top of the chamber to a swivel lock by a neck. The sizes of the disc and the chamber are selected so that the disc can freely rotate inside the chamber. The sizes of the disc and the opening in the chamber are also selected so that the neck can be moved from left to right with respect to its longitudinal axis. A locking pin with a base and a shaft is secured to the swivel lock to attach the tag to an article. The shaft passes through an opening in the article (such as a buttonhole in clothing, an opening for a shoestring or an opening for a baseball cap) and is retained by the base. The tip of the shaft is then inserted into the swivel lock to secure the tag to the article. Preferably, the locking pin and swivel lock are designed so that they cannot be easily separated once the locking pin is locked into the swivel lock. Typically, the tag is removed by the purchaser of the article by cutting the end of locking pin shaft that passes through the opening in the swivel lock. The side of the swivel lock opposite the locking pin has a “scissors” logo that indicates where the locking pin shaft is cut.

The two housing sections are snap-fit or sealed together in a manner that makes it difficult to separate them and remove the electronic security device. The housing sections are preferably welded together but they can also be joined using an adhesive. The housing sections are formed from a thermoplastic material such as polystyrene and the lock and pin are preferably made from polypropylene, polyethylene or a blend of both materials. However, the invention is not limited by the type of materials used to form the tag and a variety of different materials can be used. The security tag can include a radio frequency identification (RFID) device or an electronic article surveillance (EAS) device located inside the housing. This allows the article to which the tag is attached to be electronically identified and also provides security against theft.

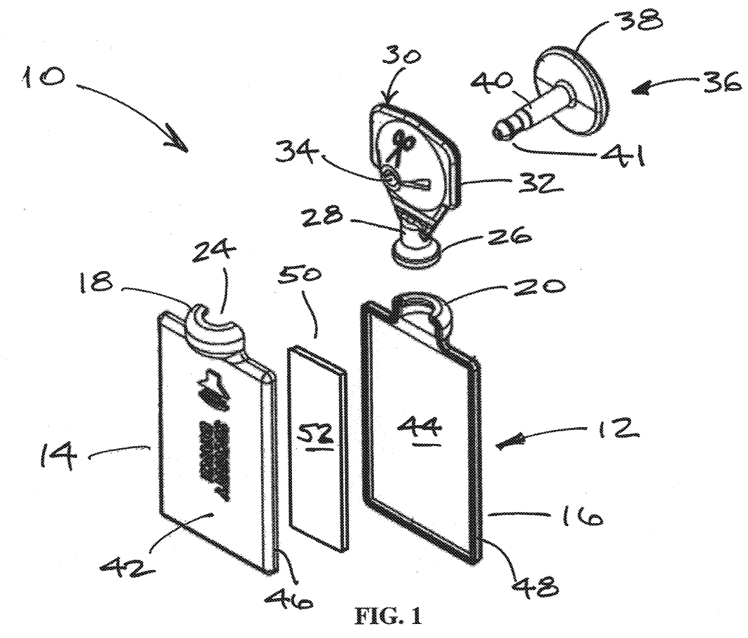

Referring now to the drawings, FIGS. 1-8 show an embodiment of the security tag with a swivel head 10 that includes a housing 12 formed by first and second sections 14, 16 that are joined by a snap-fit connection, glue, welding, or other such means. The first and second sections 14, 16 are connected on one end to a pair of opposing walls 18, 20 that curve outwardly to form a chamber 22 and an opening 24 when the sections 14, 16 are joined together. A swivel lock 30 that includes a body 32 connected by a neck 28 to a retainer 26 is attached to the housing 12 by the retainer 26, which is rotatably disposed in the chamber 22 and can be either disc-shaped or substantially round. The neck 28 extends through the opening 24 and connects the retainer 26 to the body 32 of the swivel lock 30. The swivel lock 30 preferably has a concave body 32 with an aperture 34 in the center that receives a locking pin 36. The locking pin 36 has a flat, circular base 38 with a shaft 40 extending from one side of the base 38 to a bulbous distal end 41. The shaft 40 is passed through an opening in an article (e.g., a button hole in a piece of clothing) and snap-fit into the aperture 34 in the swivel lock 30. The locking pin 36 can only be removed from the swivel lock 30 by damaging or destroying the security tag 10.

FIG. 1 shows the two sections 14, 16 of the housing 12 before they are joined together. The housing sections 14, 16 have side walls 42, 44 that are preferably rectangular in shape; however, other shapes are contemplated by the present invention including round, oval, triangular and multi-sided (i.e., five or more sides). Each of the housing sections 14, 16 has a perimetrical side wall 46, 48 that extends outwardly from the side wall 42, 44. When the housing sections 14, 16 are joined together, the perimetrical side walls 46, 48 contact each other and together with the side walls 42, 44 form an enclosed space 50 therebetween. A security device 52, such as a radio frequency identification (RFID) tag or electronic article surveillance (EAS) tag, can be positioned in the enclosed space 50 before the housing sections 14, 16 are joined together.

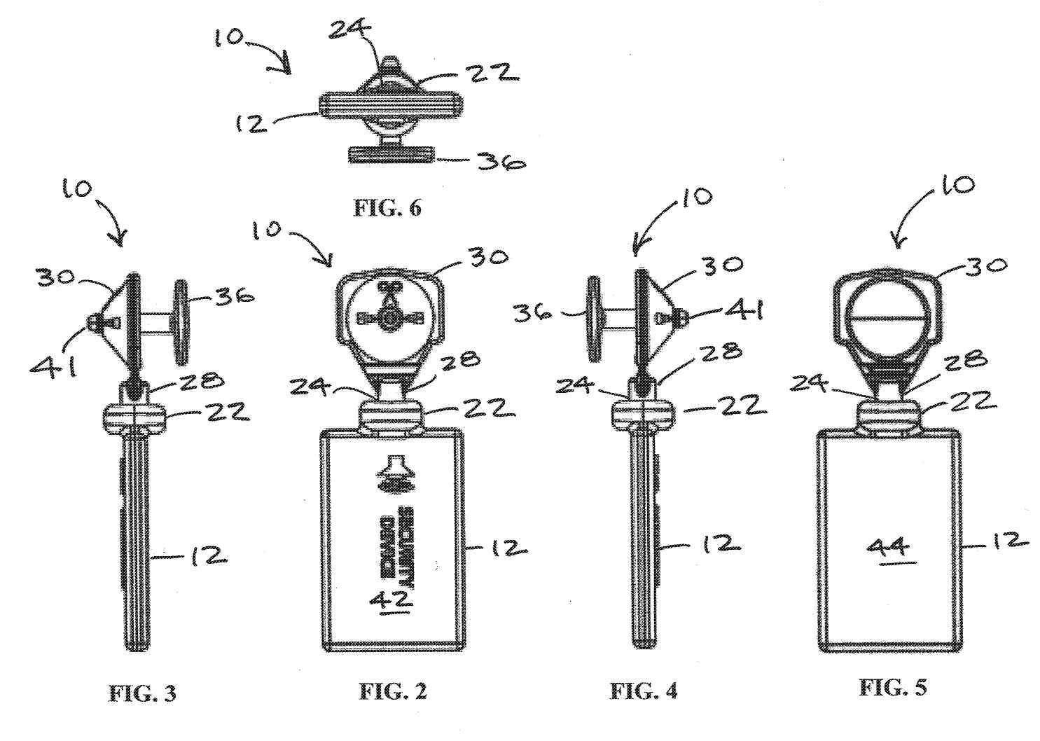

FIGS. 2-6 show different views of the security tag with a swivel head 10 after the two housing sections 14, 16 are joined together and the locking pin 36 is inserted in the swivel lock 30. The retainer 26 is rotatably positioned in the chamber 22 and the neck 28 connects the retainer 26 to the swivel lock 30 through the opening 24 in the chamber 22.

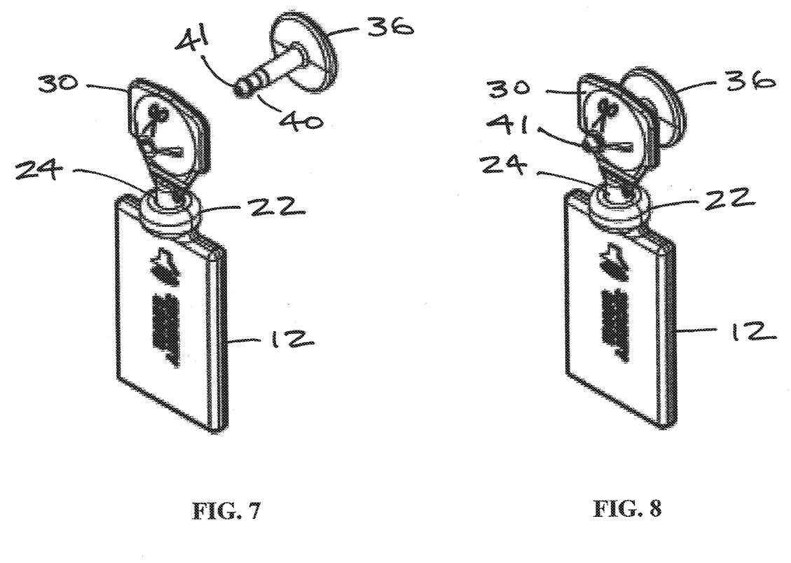

FIGS. 7-8 show the assembled security tag housing 12 before the locking pin 36 is inserted into the swivel lock 30 (FIG. 7) and after the locking pin 36 is inserted into the swivel lock 30 (FIG. 8).

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A security tag with a swivel head comprising:
a housing comprising first and second housing sections having first and second side walls with perimeters, respectively, and first and second ends;
an electronic security device disposed between the two housing sections;
first and second opposing outwardly curved walls connected to the first end of each housing section, wherein when the two housing sections are joined together to form the housing, the opposing outwardly curved walls form a chamber and an opening opposite the housing;
a swivel lock comprising a body connected to a retainer by a neck, wherein the retainer is rotatably disposed in the chamber and the neck passes through the opening; and
a locking pin that is secured to the body of the swivel lock.

2. The security tag according to claim 1, wherein the first and second housing sections have first and second perimetrical side walls that extend from the perimeters of the first and second side walls, respectively, and wherein, when the first and second housing sections are joined together, an enclosed space bounded by the first and second perimetrical side walls is formed therebetween.

3. The security tag according to claim 1, wherein the retainer is disc-shaped or substantially round and has a diameter.

4. The security tag according to claim 2, wherein the opening has a diameter that is smaller than the diameter of the retainer.

5. The security tag according to claim 1, electronic security device is a radio frequency identification (RFID) device or an electronic article surveillance (EAS) device.

6. The security tag according to claim 1, wherein the body of the swivel lock is concave and has an aperture.

7. The security tag according to claim 6, wherein the locking pin has a base and a shaft that extends from the base, and wherein the shaft is inserted into the aperture in the body of the swivel lock to secure the locking pin to the swivel lock.

8. The security tag according to claim 7, wherein the locking pin has a bulbous distal end, wherein the bulbous distal end passes through the aperture in the swivel lock body and cannot be removed without damaging the swivel lock body.

9. The security tag according to claim 1, wherein the base of the locking pin is substantially flat and substantially round.

10. The security tag according to claim 1, wherein the swivel lock has a longitudinal axis that extends from the retainer through the neck to the body, and wherein the retainer extends radially from the longitudinal axis and the neck.

11. A security tag with a swivel head comprising:
a housing comprising first and second housing sections having first and second side walls, respectively, that define an enclosed space therebetween and first and second ends;
an electronic security device disposed in the enclosed space;
a globe-shaped structure attached to the first end of the housing having a hollow chamber and an opening;
a swivel lock comprising a body connected to a retainer by a neck, wherein the retainer is rotatably disposed in the chamber and the neck passes through the opening, and wherein the retainer is sized so that it is too large to pass through the opening; and
a locking pin that is secured to the body of the swivel lock.

12. The security tag according to claim 11, wherein the first and second housing sections each have perimetrical side walls that extend from the perimeter of the side walls, and wherein the perimetrical side walls have first and second perimeters, respectively.

13. The security tag according to claim 12, wherein the perimeter of the first side wall is less than the perimeter of the second side wall so that the first side wall snugly engages the second side wall and the first and second housing sections snap-fit together.

14. The security tag according to claim 11, wherein the retainer is disc-shaped or substantially round.

15. The security tag according to claim 11, electronic security device is a radio frequency identification (RFID) device or an electronic article surveillance (EAS) device.

16. The security tag according to claim 11, wherein the body of the swivel lock is concave and has an aperture.

17. The security tag according to claim 16, wherein the locking pin has a base and a shaft that extends from the base, and wherein the shaft is inserted into the aperture in the body of the swivel lock to secure the locking pin to the swivel lock.

18. The security tag according to claim 17, wherein the locking pin has a bulbous distal end, wherein the bulbous distal end passes through the aperture in the swivel lock body and cannot be removed without damaging the swivel lock body.

19. The security tag according to claim 17, wherein the base of the locking pin is substantially flat and substantially round.

20. The security tag according to claim 11, wherein the swivel lock has a longitudinal axis that extends from the retainer through the neck to the body, and wherein the retainer extends perpendicularly from the longitudinal axis and the neck.
